(19) United States
(12) Patent Application Publication
(10) Pub. No.: US 2005/0219200 A1
(43) Pub. Date: Oct. 6, 2005

(54) Fingerprint sensing pixel with a larger aperture

(76) Inventor: Chien-Sen Weng, Jhubei City (TW)

Correspondence Address: DUANE MORRIS, LLP;IP DEPARTMENT, ONE LIBERTY PLACE, PHILADELPHIA, PA, 19103-7396, US

(21) Appl. No.: 10/813,987

(22) Filed: Mar. 31, 2004

(51) Int. Cl. G09G 5/00

(52) U.S. Cl. 345/104

(57) ABSTRACT

In a thin film transistor-based resistive-type fingerprinting touch screen panel, the size of the contact metal layer connecting the drain electrode of the TFT and the ITO sensing electrode in each of the pixel regions of the touch screen panel is reduced, thus increasing the aperture of the pixel region. Having a greater aperture, more of the backlighting from the LCD display panel usually positioned behind the touch screen panel is transmitted through the touch screen panel, making that region brighter.

### FIELD OF THE INVENTION

The present invention relates to fingerprinting touch screen panels and more particularly to fingerprinting touch screen panels having high aperture ratio to allow more backlighting to transmit through the touch screen panels.

### BACKGROUND OF THE INVENTION

Touch screen panels are commonly used in combination with liquid crystal display (LCD) devices. In many such applications, the touch screen panels function as contact switches to allow graphically rendered buttons and switches on the LCD screen to function as if they are real buttons and switches. More recent development in the touch screen panel technology has produced touch screen panels for acquiring fingerprint images directly on the touch screen panels. A general description of an example of such fingerprinting touch screen panel is illustrated in FIGS. 1A-1C.

FIG. 1A is a cross-sectional view of a thin film transistor-based resistive-type touch screen panel 100 for acquiring fingerprint images. The touch screen panel 100 is usually used in combination with a LCD panel 300 having a backlight system 310. The touch screen panel 100 is comprised of a lower substrate 110 and an upper substrate 150. The upper substrate 150 is typically made of a polyethylene terephthalate (PET) film or a thin glass sheet, which is flexible. The underside of the upper substrate 150 is a thin transparent conducting layer of gold 152. The lower substrate 110 has an array of sensing electrodes (usually made of transparent conductive material, such as, indium-tin-oxide (ITO) or indium-zinc-oxide) 112 for sensing the undulations of a human finger pressing down on the upper substrate 150 to acquire an image of the finger's fingerprint. The lower substrate 110 is positioned beneath the upper substrate 150 and is separated from the upper substrate 150 by a gap of approximately 100 to 300 micrometers. Each of the sensing electrodes 112 is connected to a thin film transistor (TFT), which together comprising a pixel of the touch screen panel, for sensing the fingerprint image. The operational details of this type of fingerprinting touch screen panels are well-known in the touch panel and LCD display industry and need not be discussed here.

FIG. 1B is a plan view schematic illustration of a single fingerprint sensing pixel region 101 of the lower substrate 110. FIG. 1C is a cross-sectional schematic illustration of the pixel region 101 of the lower substrate 110, along line A-A in FIG. 1B, showing the representative structure of a pixel of the conventional touch screen panel 100 used for fingerprinting. Referring to FIGS. 1B and 1C, the pixel 101 is comprised of a sensing electrode 40, usually made of transparent material such as ITO or indium zinc oxide, connected to a TFT device 102. A grid of source lines 10 and addressing lines 20 is utilized to address a particular pixel in the full array. The source line 10 and the addressing line 20 are typically conducting lines made of a metal such as aluminum. The addressing line 20 is connected to a gate electrode 22 of the TFT device 102. The source line 10 is connected to source electrodes 32, whose outlines are shown in this plan view. The source electrodes 32 extends downward through the interlayer dielectric (ILD) 66 and the gate insulation layer 64 and connected to a poly-Si dielectric layer 30 that forms the channel region of the TFT device 102. On the opposite side of the gate electrode 22, drain electrodes 33 connect the channel 30 to the same metal layer where the source line 10 is formed. The top ends of the drain electrodes 33 are connected to a drain contact metal pad 34. The drain contact metal pad 34 has extended portion 35 that extends away from the TFT structures. The source line 10 and the extended portion 35 are both formed on top of the ILD layer. As illustrated in FIG. 1C, a passivation layer 68 and an ultra high aperture (UHA) layer 70 are formed over these metal structures. The sensing electrode 40 is formed over an ultra-high-aperture (UHA) layer 70 and is connected to the extended portion 35 through a via 37.

Other than the metal features, such as the source and addressing lines 10, 20, gate electrode 22, channel region 30, source/drain electrodes 32, 33, and the extended portion 35, rest of the lower substrate 110 is made of transparent materials. Thus, each of the pixel 101 allows the backlighting of the LCD display to transmit through the touch screen panel 100. But, as illustrated in the plan view of FIG. 1B, a substantial portion of the pixel area is occupied by the non-transparent metal structures mentioned above. This is generally quantified as an aperture ratio, the ratio of the total pixel area to the transparent area. In a conventional touch screen panel of FIG. 1B, the aperture ratio is about 80%.

Most fingerprinting touch screen panels with their aperture ratio of about 80%, when placed in front of an LCD panel, transmit less backlighting compared to the remaining LCD panel regions where there is no fingerprinting touch screen panel. This results in the fingerprinting touch screen panel region of the LCD display system to appear dimmer than the rest of the LCD display area. Although this has no effect on the functional aspects of the fingerprinting touch screen panel or the LCD display, having a dimmer fingerprinting area on the LCD display screen may not be optimal for some applications for aesthetical reasons. Thus, fingerprinting touch screen panels having greater aperture ratio pixels, allowing more LCD backlighting to transmit through the touch screen panels are desired.

### SUMMARY OF THE INVENTION

According to an aspect of the present invention, an improved sensing pixel of a thin film transistor-based resistive-type fingerprinting touch screen panel comprises a thin film transistor having a poly-Si film layer forming a channel region and at least one drain electrode connecting the poly-Si film layer to a contact metal pad. A sensing electrode of the pixel is connected to the contact metal pad through a via, wherein at least a portion of the via overlaps the poly-Si film layer when viewed through the sensing electrode. The sensing electrode may be made of a transparent material such as indium tin oxide or indium zinc oxide.

According to another embodiment of the present invention, a thin film transistor-based resistive-type fingerprinting touch screen panel is also disclosed. The touch screen panel comprises an upper substrate and a lower substrate positioned beneath the upper substrate. The upper substrate is usually a flexible PET film having a conductive coating layer on the underside. The lower substrate comprises an array of thin film transistor-based sensing pixels. Each of the sensing pixels comprises a thin film transistor having a poly-Si film layer forming a channel region and at least one drain electrode connecting the poly-Si film layer to a contact metal pad. A sensing electrode of the pixel is connected to the contact metal pad through a via, wherein at least a portion of the via overlaps the poly-Si film layer when viewed through the sensing electrode. The sensing electrode may be made of a transparent material such as indium tin oxide or indium zinc oxide.

According to another embodiment of the present invention, a display system having a fingerprinting feature is also disclosed. The display system comprises a LCD panel, a backlight for the LCD panel behind the LCD panel and a thin film transistor-based resistive-type fingerprinting touch screen panel in front of the LCD. The fingerprinting touch screen panel comprises an upper substrate and a lower substrate positioned beneath the upper substrate. The lower substrate comprises an array of thin film transistor-based sensing pixels, each of the sensing pixels comprising a thin film transistor having a poly-Si film layer forming a channel region and at least one drain electrode connecting the poly-Si film layer to a contact metal pad. A sensing electrode of the pixel is connected to the contact metal pad through a via in a manner such that at least a portion of the via overlaps the poly-Si film layer when viewed through the sensing electrode.

### BRIEF DESCRIPTION OF THE DRAWING

FIG. 1A is a schematic cross-sectional illustration of a typical LCD display panel with a fingerprinting touch screen panel in front of the LCD panel.

FIG. 1B is a schematic plan view illustration of a pixel region of the fingerprinting touch screen panel of FIG. 1A.

FIG. 1C is a schematic cross-sectional illustration of the pixel region of FIG. 1B.

FIG. 2A is a schematic plan view illustration of a pixel region of a fingerprinting touch screen panel according to an embodiment of the present invention.

FIG. 2B is a schematic cross-sectional illustration of the pixel region illustrated in FIG. 2A.

The features shown in the above-referenced drawings are schematic only and are not drawn to scale. Like reference numbers represent like elements.

### DETAILED DESCRIPTION

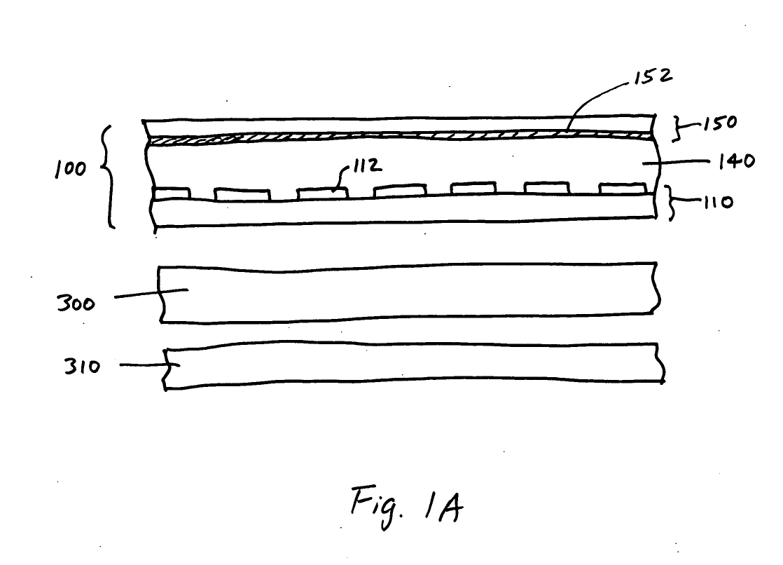

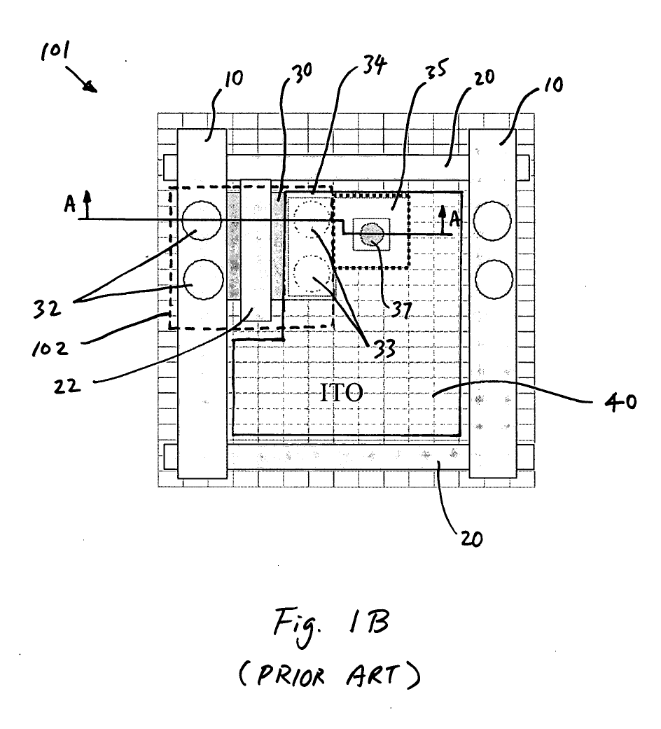

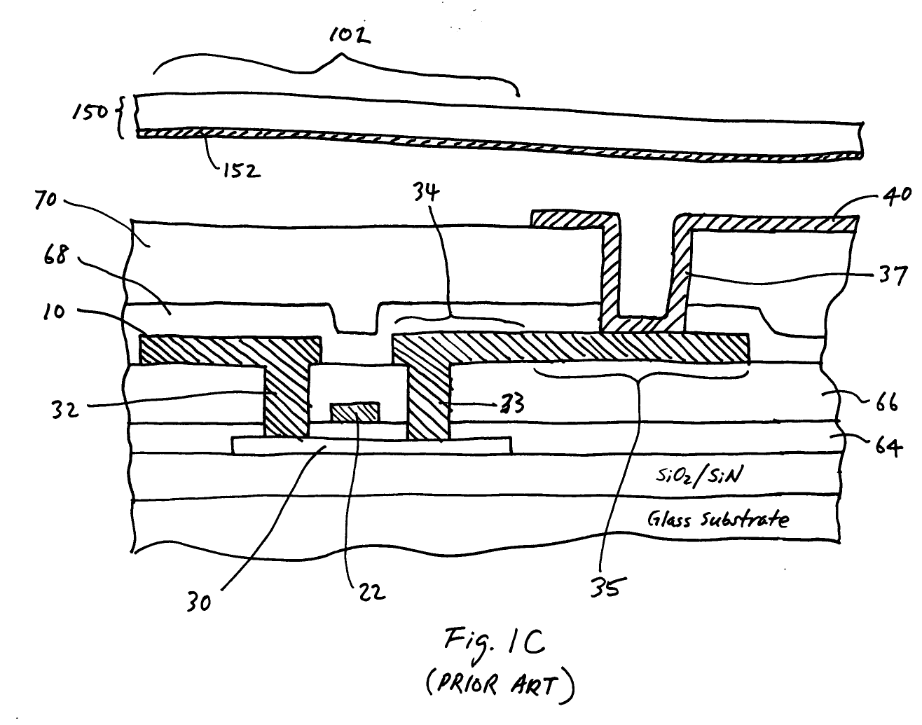

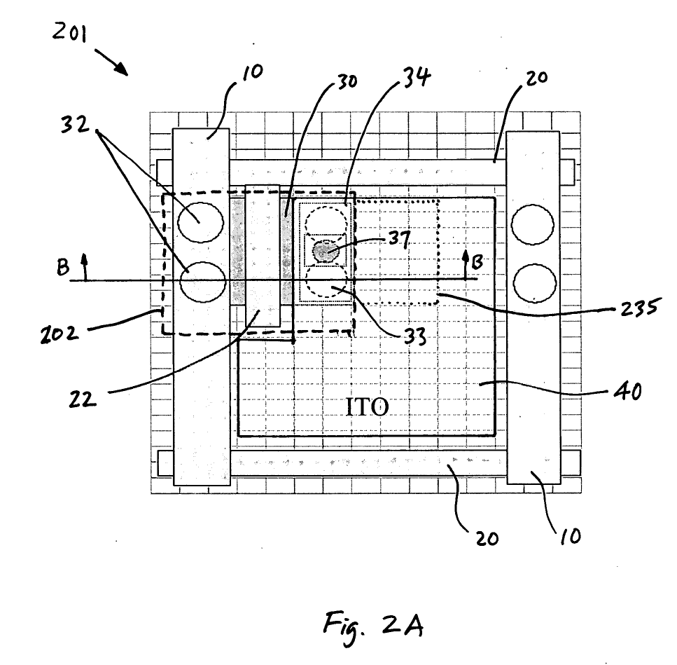

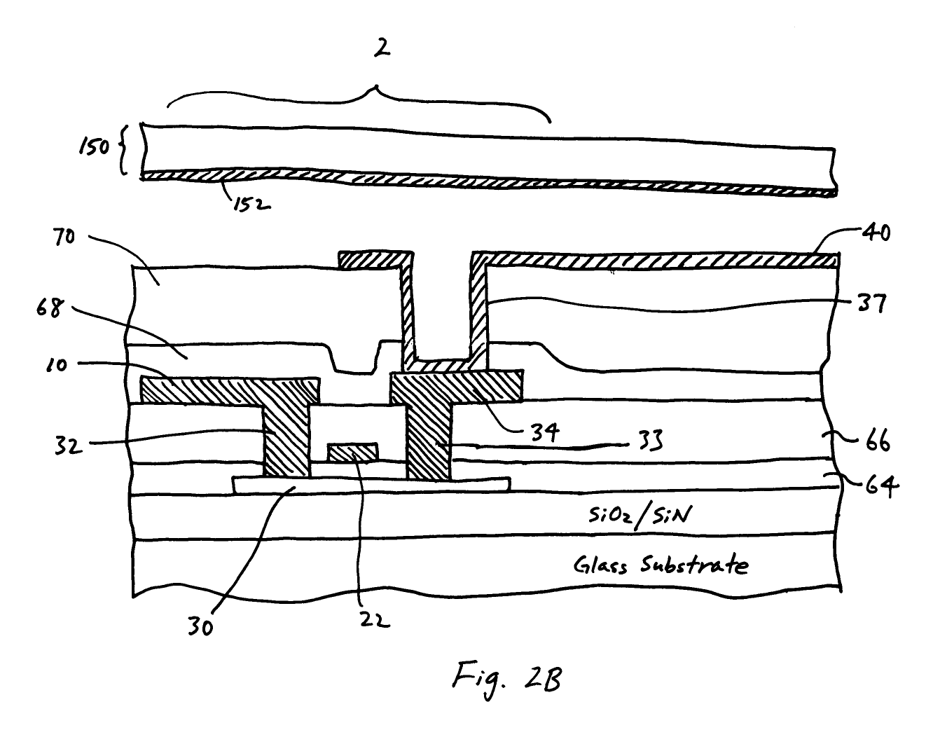

FIG. 2A illustrates a plan view of a pixel region 201 of an improved fingerprinting touch screen panel according to an embodiment of the present invention. Comparing this improved structure to the pixel region 101 of the conventional fingerprinting touch screen panel 100 of FIG. 1C, the extended portion 35 of the drain contact metal pad 34 has been removed. This is represented by a phantom line 235 showing the outline of where the extended portion 35 would be in a conventional fingerprinting touch screen panel. Thus, in the improved fingerprinting touch screen panel according to an aspect of the present invention, the total area of opaque metalized portion in the pixel region 201 has been reduced. In turn, the transparent region is larger and the aperture ratio of the pixel region 201 is higher than the aperture ration of the pixel region 101, for example, of the conventional fingerprinting touch screen panel 100.

To achieve this improvement, the via 37 connecting the ITO sensing electrode 40 to the drain electrodes 33 of the TFT device 202 has been moved so that at least a portion of the via 37 overlaps the poly-Si film layer 30 when viewed through the sensing electrode 40 as shown in FIG. 2A. As illustrated in the plan view FIG. 2A, which is a view through the sensing electrode 40, the via 37, while contacting the contact metal pad 34, overlaps the poly-Si layer 30. Actually, in this example, the via 37 is completely overlaps the poly-Si layer 30. In a preferred embodiment of the present invention, a substantial portion or all of the via 37 overlaps the outline of the poly-Si film layer 30 when viewed through the sensing electrode 40 so that the size of the contact metal pad 34 is minimized and need not extend beyond the outline of the poly-Si film layer 30. Of course it should be noted that the via 37 overlapping the poly-Si film layer 30 does not refer to the via 37 and the poly-Si film layer 30 directly contacting each other since these two features are separated by the gate insulation layer 64 and the ILD layer 66. The overlapping describes the spatial relationship between the via 37 and the poly-Si layer 30 in the vertical direction so that their outlines or footprint overlaps when they are in positional relationship according to a preferred embodiment of the present invention.

This structure can be seen more clearly in the cross-sectional illustration of FIG. 2B. The drain electrodes 33 terminate on top at the contact metal 34. The via 37 of the ITO sensing electrode 40 is aligned longitudinally with the drain electrodes 33 and contacts the contact metal pad 34. Unlike the structure of the pixel region 101 of the conventional fingerprinting touch screen panel 100, the contact metal pad 34 in the improved pixel region 201 does not have the extended portion 35.

With the removal of the extended portion 35 of the contact metal pad 34, the improved pixel region 201 may achieve an aperture ratio greater than about 80%, which is the typical aperture ratio value in the conventional resistive-type fingerprinting touch screen panels.

While the foregoing invention has been described with reference to the above embodiments, various modifications and changes can be made without departing from the spirit of the invention.

1. A sensing pixel of a thin film transistor-based resistive-type fingerprinting touch screen panel, the sensing pixel comprising:
a thin film transistor having a poly-Si film layer forming a channel region and at least one drain electrode connecting the poly-Si film layer to a contact metal pad;
a sensing electrode connected to the contact metal pad through a via, wherein at least a portion of the via overlaps the poly-Si film layer when viewed through the sensing electrode.

2. The sensing pixel of claim 1, wherein a substantial portion of the via overlaps the poly-Si film layer when viewed through the sensing electrode.

3. The sensing pixel of claim 1, wherein the sensing electrode comprises indium tin oxide or indium zinc oxide.

4. The sensing pixel of claim 1, wherein the sensing pixel having an aperture ratio of greater than about 80%.

5. A thin film transistor-based resistive-type fingerprinting touch screen panel comprising:
an upper substrate;
a lower substrate beneath the upper substrate, wherein the lower substrate comprises an array of thin film transistor-based sensing pixels, each of the sensing pixels comprising:
a thin film transistor having a poly-Si film layer forming a channel region and at least one drain electrode connecting the poly-Si film layer to a contact metal pad;
a sensing electrode connected to the contact metal pad through a via, wherein at least a portion of the via overlaps the poly-Si film layer when viewed through the sensing electrode.

6. The touch screen panel of claim 5, wherein a substantial portion of the via overlaps the poly-Si film layer.

7. The touch screen panel of claim 5, wherein the sensing electrode comprises indium tin oxide or indium zinc oxide.

8. The touch screen panel of claim 5, wherein the sensing pixel having an aperture ratio of greater than about 80%.

9. A display system having a fingerprinting feature comprising:
a LCD panel;
a backlight for the LCD panel;
a thin film transistor-based resistive-type fingerprinting touch screen panel over the LCD panel, wherein the thin film transistor-based resistive-type fingerprinting touch screen panel comprises:
an upper substrate;
a lower substrate beneath the upper substrate, wherein the lower substrate comprises an array of thin film transistor-based sensing pixels, each of the sensing pixels comprising:
a thin film transistor having a poly-Si film layer forming a channel region and at least one drain electrode connecting the poly-Si film layer to a contact metal pad;
a sensing electrode connected to the contact metal pad through a via, wherein at least a portion of the via overlaps the poly-Si film layer when viewed through the sensing electrode.

10. The touch screen panel of claim 9, wherein a substantial portion of the via overlaps the poly-Si film layer.

11. The touch screen panel of claim 9, wherein the sensing electrode comprises indium tin oxide or indium zinc oxide.

12. The touch screen panel of claim 9, wherein the sensing pixel having an aperture ratio of greater than 80%.

13. The sensing pixel of claim 1, wherein the sensing electrode is transparent.

14. The touch screen panel of claim 5, wherein the sensing electrode is transparent.

15. The touch screen panel of claim 9, wherein the sensing electrode is transparent.

16. The touch screen panel of claim 5, wherein the upper substrate is made of PET.

17. The touch screen panel of claim 9, wherein the upper substrate is made of PET.
